(19) United States
(12) Patent Application Publication
(10) Pub. No.: US 2019/0340321 A1
(43) Pub. Date: Nov. 7, 2019

(54) Friction/Tied-Interface Used In FEA For Manufacturing Products/Parts

(71) Applicant: Livermore Software Technology Corporation, Livermore, CA (US)

(72) Inventor: Zhidong Han, Livermore, CA (US)

(21) Appl. No.: 15/972,586

(22) Filed: May 7, 2018

(51) Int. Cl. G06F 17/50

(52) U.S. Cl. CPC G06F 17/5018; G06F 2217/12; G06F 2217/16

(57) ABSTRACT

Systems and methods of calculating friction/tied-interface effects in time-marching simulation for improvement of a product/part are disclosed. FEA model, representing a product/part, contains first and second sub-models connected with each other via a friction/tied-interface. The friction/tied-interface connects at least one perimeter nodal point in the first sub-model to at least one element face in the second sub-model. Each perimeter nodal point is associated with a particular one of the at least one element face. Numerically-calculated structural behaviors of the product/part under a design condition are obtained by conducting a time-marching simulation using the FEA model. Numerically-calculated structural behaviors at each of a number of solution cycle include effects from respective sets of counterbalance corner nodal forces applied on the at least one element face. Each set of counterbalance corner nodal forces is configured for cancelling out angular moment caused by lateral force acted at each associated perimeter nodal point.

### FIELD

The invention generally relates to computer aided engineering analysis, more particularly to methods and systems for improving products/parts based on numerical simulations using friction/tied-interface in FEA (Finite Element Analysis).

### BACKGROUND

Differential equations are employed in solving problems in continuum mechanics. Many numerical procedures have been used. One of the most popular methods is finite element analysis (FEA), which is a computerized method widely used in industry to model and solve engineering problems relating to complex systems such as three-dimensional non-linear structural design and analysis. FEA derives its name from the manner in which the geometry of the object under consideration is specified. With the advent of the modern digital computer, FEA has been implemented as FEA software. Basically, the FEA software is provided with a grid-based model of the geometric description and the associated material properties at each point within the model. In this model, the geometry of the system under analysis is represented by solids, shells and beams of various sizes, which are called elements. The vertices of the elements are referred to as nodes. The model is comprised of a finite number of elements, which are assigned a material name to associate with material properties. The model thus represents the physical space occupied by the object under analysis along with its immediate surroundings. The FEA software then refers to a table in which the properties (e.g., stress-strain constitutive equation, Young's modulus, Poisson's ratio, thermo-conductivity) of each material type are tabulated. Additionally, the conditions at the boundary of the object (i.e., loadings, physical constraints, etc.) are specified. In this fashion a model of the object and its environment is created.

Once the model is defined, FEA software can perform a numerical simulation of the physical behaviors under the specified loading or initial conditions. FEA software is used extensively in the manufacturing industry to numerically simulate all aspects of manufacturing procedure of products/parts (e.g., automobile and/or parts). Such numerical simulations provide valuable insight to engineers/scientists who are able to improve the performance and safety of products and to bring new models to the market more quickly.

Some of numerical simulations (e.g., time-marching simulations) are performed in time domain meaning the FEA is computed at many solution cycles starting from an initial solution cycle, at each subsequent solution cycle, the simulation time is incremented by a time step referred to as At. One type of time-marching simulations is to simulate an impact event (e.g., car crash, drop test of a product, etc.).

It is quite often that various portions of a product/part that are represented by respective sub-models are separately created. Then the sub-models are connected together to form a FEA model via tied-interface to represent the entire product/part. Using tie-interface has been proven very useful. For example, thousands of spot welds in an automobile are modeled with tied-interface.

Another situation is to numerically-simulate contact friction between two portions of a product/part either initially or during simulation. Instead tied-interface, friction-interface is used for such a situation. Both tied-interface and friction-interface share substantially similar physics phenomena, hence being handled with same technique.

However, many prior art approaches to treat friction-interface or tied-interface are ad hoc with quite a few simplified assumptions and approximations. For example, angular moments as a result of the offset between two sub-models or portions are generally ignored or omitted. With the advent of computers, newer FEA model becomes bigger and finite elements in the FEA model becomes smaller. As a result, prior art approaches are incorrect for calculating effects of friction/tied-interface.

In order to use numerical simulation results of a FEA model containing friction/tied-interface for assisting engineers/scientists to properly design and/or manufacture a product or part, it would be desirable to have improved methods and systems for calculating friction/tied-interface effects in a time-marching simulation for improvement of a product or part.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Systems and methods of using time-marching simulations in improvement of a product or part are disclosed. According to one aspect of the disclosure, Finite Element Analysis (FEA) model representing a product/part is received in a computer system. FEA model contains first and second sub-models connected with each other via a friction/tied-interface. A friction/tied-interface connects at least one perimeter nodal point in the first sub-model to at least one element face in the second sub-model. Each perimeter nodal point is associated with a particular one of the at least one element face based on a set of friction/tied-interface criteria. Numerically-calculated structural behaviors of the product/part under a design condition are obtained by conducting a time-marching simulation using the FEA model in a number of solution cycles. Numerically-calculated structural behaviors at each solution cycle include effects from respective sets of counterbalance corner nodal forces applied on the at least one element face. Each set of counterbalance corner nodal forces is used for cancelling out angular moment caused by lateral force acted at each perimeter nodal point.

Furthermore, the set of friction/tied-interface criteria includes determining a normal projection location of each perimeter nodal point to a particular one of the at least one element face, and the particular one of the at least one element face is the one that the normal projection point is located thereon.

Objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1 is a flowchart illustrating an example process of calculating friction/tied-interface effects in a time-marching simulation for improvement of a product or part, according to an embodiment of the invention;

FIG. 2 is a two-dimensional diagram showing an example FEA model containing first and second portions or sub-models connected with each other via a friction/tied-interface in accordance with an embodiment of the invention;

FIG. 3 is a diagram showing a first example friction/tied-interface in accordance with an embodiment of the invention;

FIG. 4 is a diagram showing a second example friction/tied-interface in accordance with an embodiment of the invention;

FIG. 5 is a schematic diagram showing an example fixed relative orientation between a perimeter nodal point and an associated element face in accordance with one embodiment of the invention;

FIGS. 6A-6D are diagrams showing example shapes of element face in accordance with one embodiment of the invention;

FIGS. 7A-7C are diagrams showing an example set counterbalance corner nodal forces applied on a quadrilateral element face and lateral force acted at an associated perimeter nodal point, according to one embodiment of the invention;

FIGS. 7D-7F are diagrams showing an example set counterbalance corner nodal forces applied on a triangular element face and lateral force acted at an associated perimeter nodal point, according to one embodiment of the invention;

FIGS. 8A-8B are two-dimensional schematic diagrams showing an example relationship between lateral force at a perimeter nodal point and corresponding set of counterbalance corner nodal forces, according to one embodiment of the invention; and

FIG. 9 is a function block diagram showing salient components of an exemplary computer, in which one embodiment of the invention may be implemented.

### DETAILED DESCRIPTION

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Additionally, used herein, the terms “horizontal”, “vertical”, “upper”, “lower”, “top”, “bottom”, “right”, “left”, “front”, “back”, “rear”, “side”, “middle”, “upwards”, and “downwards” are intended to provide relative positions for the purposes of description, and are not intended to designate an absolute frame of reference. Further, the order of blocks in process flowcharts or diagrams representing one or more embodiments of the invention do not inherently indicate any particular order nor imply any limitations in the invention.

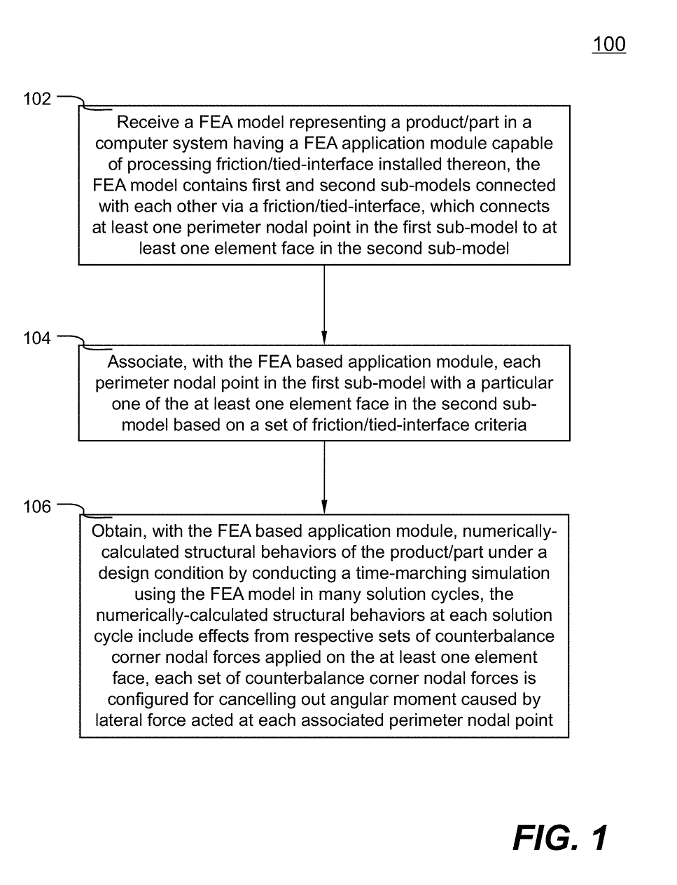

Embodiments of the invention are discussed herein with reference to FIG. 1 to FIG. 9. However, those skilled in the art will readily appreciate that the detailed description given herein with respect to these figures is for explanatory purposes as the invention extends beyond these limited embodiments.

Referring first to FIG. 1, it is shown a flowchart illustrating an example process 100 of calculating friction/tied-interface effects in a time-marching simulation for improvement of a product or part. Example product or part can be an automobile or part or component of a car. Another example product or part includes electronic device (e.g., cellular phone).

Process 100 starts by receiving a finite element analysis (FEA) model representing a product or part, in a computer system (e.g., computer system 900) at action 102. A FEA based application module capable of processing friction/tied-interface is installed on the computer system. The FEA model contains at least first and second sub-models each representing corresponding portion of the product or part. The first and the second sub-models are connected with each other via a friction/tied-interface. In particular, each friction/tied-interface connects a perimeter nodal point in the first sub-model to a corresponding element face on outside surface of the second sub-model.

Next, at action 104, each perimeter nodal point in the first sub-model is associated with a particular one of the at least one element face of the second sub-model based on a set of friction/tied-interface criteria. The association can be one or more perimeter nodal points to one particular element face. Once associated, each perimeter nodal point is in a fixed relative orientation with respect to the associated element face.

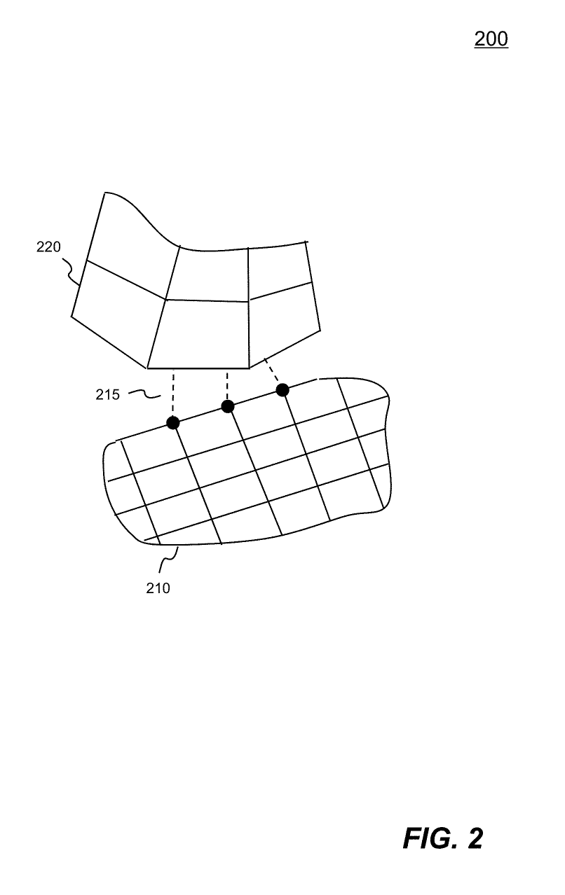

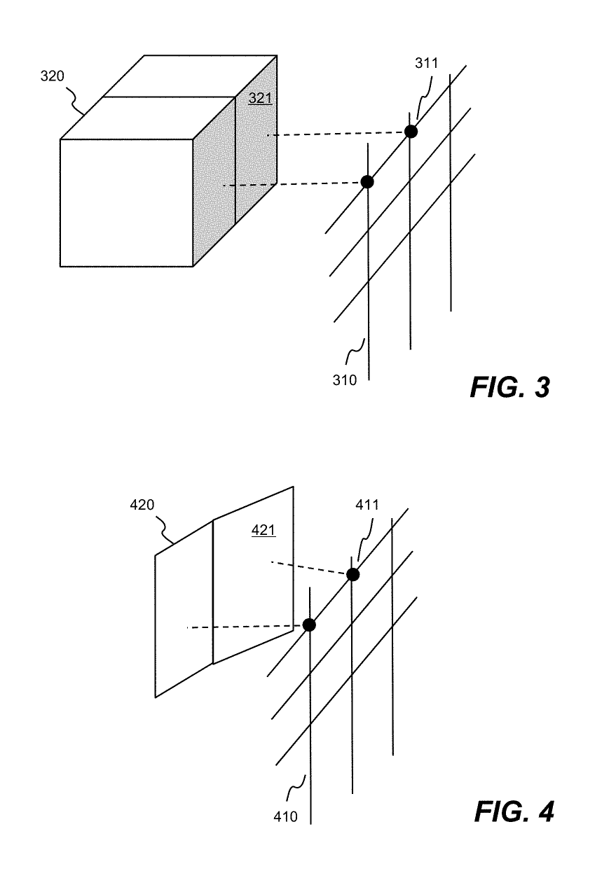

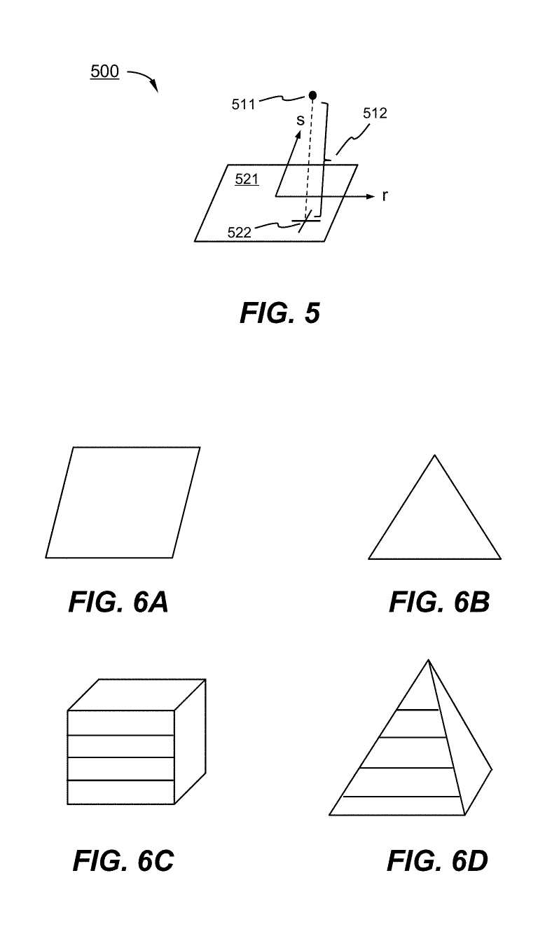

FIG. 2 is a two-dimensional diagram showing an example FEA model 200 containing a first sub-model 210 and a second sub-model 220 connected with each other via a friction/tied-interface 215. One example of using friction/tied-interface is spot weld connecting two sheet metals. Another example is to model glue between two portions of a product or part. FIG. 3 shows a first example friction/tied-interface. The first sub-model 310 contains a number of perimeter nodal points 311, while the second sub-model 320 has at least one element face 321. The second sub-model 320 is modeled with three-dimensional solid finite elements in the first example. In the second example friction/tied-interface shown in FIG. 4, the first sub-model 410 contains a number of perimeter nodal points 411 and the second sub-model 420 contains a number of element faces 421. The second sub-model 420 contains two-dimensional plate finite element.

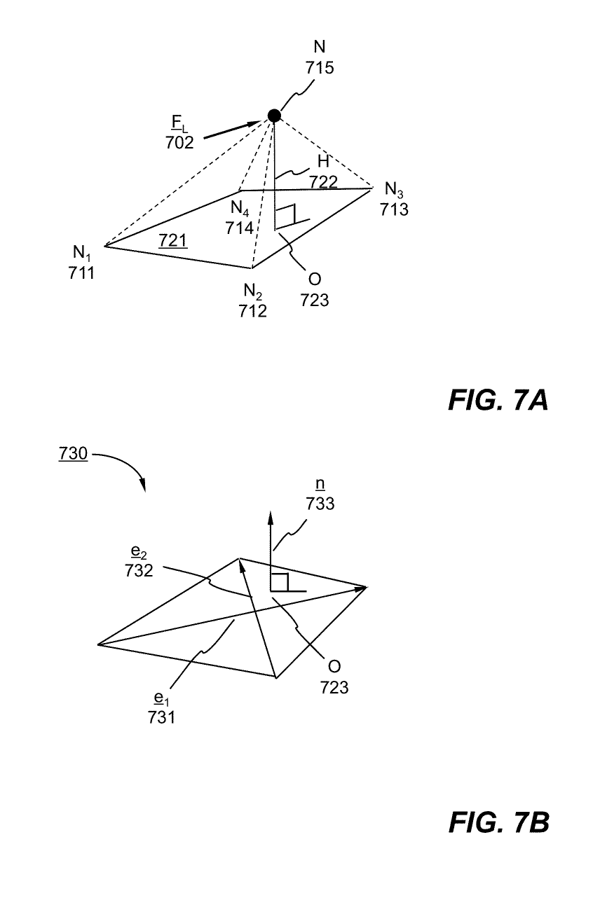

Once the perimeter nodal point is associated with a particular element face, the relative orientation is fixed. FIG. 5 is a schematic diagram illustrating an example fixed relative orientation 500 between a perimeter nodal point 511 and an associated element face 521. In the example fixed relative orientation 500, the normal projection point 522 of the perimeter nodal point 511 is located within the element face 521. The shortest distance 512 between the perimeter nodal point 511 and the element face 521 is along the normal vector of the element face 521 (i.e., a vector perpendicular to the element face 521). The fixed relative orientation includes the distance 512 and local coordinates of the normal projection point 522. Local coordinate of an element face can be defined with many well known schemes, for example, an r-s coordinate system shown in FIG. 5.

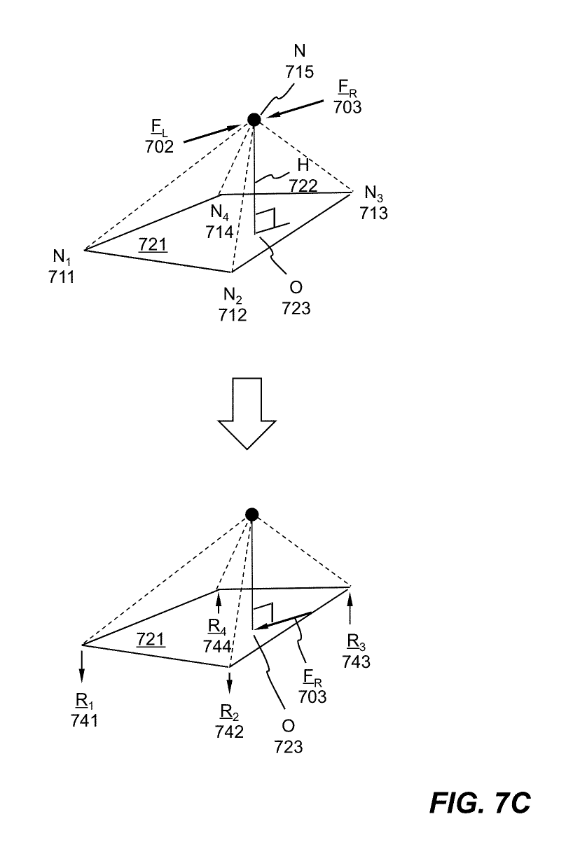

Element face can be one of the element faces of a three-dimensional solid finite element or a shape of a two-dimensional plate finite element. Various example shapes of element faces are shown in FIGS. 6A-6D. FIG. 6A shows a quadrilateral shape of a plate element, while FIG. 6B shows a triangular shape. For three-dimensional finite elements, FIG. 6C shows a rectangular shape element face of a hexahedral element. A triangular shape element face of a tetrahedral element is shown in FIG. 6D.

Referring back process 100, at action 106, numerically-calculated structural behaviors of a product or part under a design condition are obtained by conducting a time-marching simulation using the FEA model. The time-marching simulation is carried out with the FEA based application module in a number of solution cycles. Numerically-calculated structural behaviors at each solution cycle include several effects, in particular, effects from respective sets of counterbalance corner nodal forces applied on the at least one element face. Each set of counterbalance corner nodal forces is configured for canceling out an angular moment caused by a lateral force acted at each associated perimeter nodal point. Numerically-calculated structural behaviors are used for assisting engineers/scientists to make decisions in improvement of the product or part. For example, numerically-calculated structural behaviors may indicate weakness in certain portion of the product or part. Corrective actions either structurally or in physical manufacturing process may be applied accordingly by engineers/scientists to improve the next design. Another time-marching simulation can be conducted for the improved product or manufacturing process to verify such corrective actions.

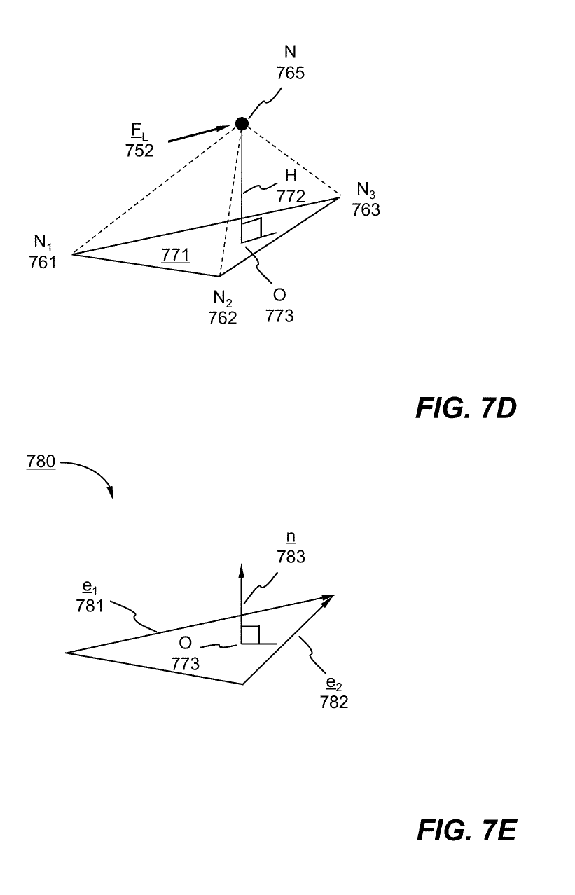

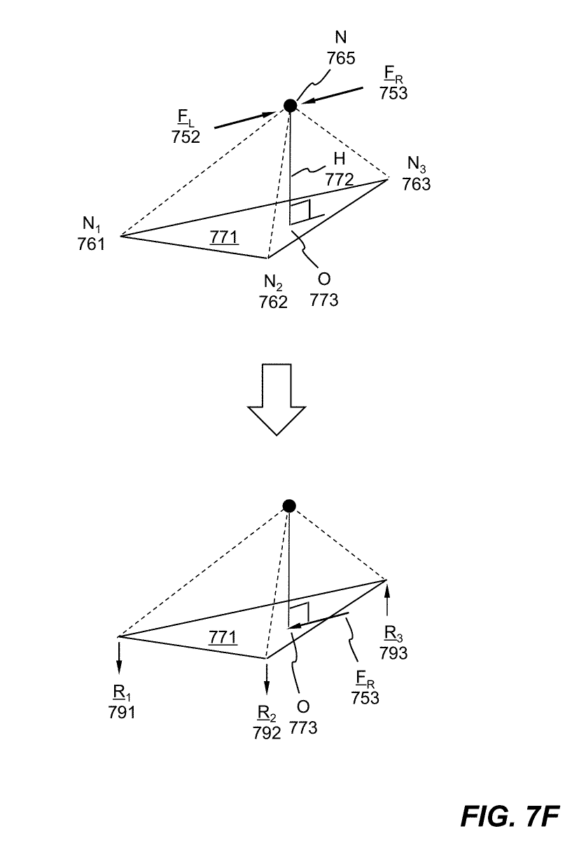

FIG. 7A is a diagram showing an example quadrilateral element face 721 with a lateral force vector F_{L} 702 acted at an associated perimeter nodal point N 715. Quadrilateral element face 721 is defined by four corner nodes N₁711, N₂ 712, N₃ 713 and N₄ 714. Vertical distance is between the perimeter nodal point N 715 and its normal projection point O 723 on the element face 721 is denoted as H 722. FIG. 7B is a diagram showing a non-orthogonal local coordinate system 730 formed by three axes (e₁731, e₂ 732, n 733) for calculating the set of counterbalance corner nodal forces. The first axis e₁ 731 is a vector defined by N₁711 and N₃ 713, while the second axis e₂ 732 is a vector defined by N₂ 712 and N₄ 714. The third axis n 733 is a vector perpendicular to a plane defined by first and second axes 731-732 with the origin at the normal projection point O 723.

FIG. 7C shows two diagrams illustrating calculation sequence of the set of counterbalance corner nodal force vectors R₁741, R₂ 742, R₃ 743 and R₄ 744 at respective corner nodes 711-714. First, a counterbalance force vector f_{R} 703 (i.e., a force equal to F_{L} 702 in opposite direction) is applied at the perimeter node N 715 as shown in the upper diagram. Then, the counterbalance force vector F_{R} 703 is laterally moved to the normal projection point O 723. And angular moment caused by the lateral force vector F_{L} 702 is canceled out by the set of counterbalance corner nodal force vectors 741-744.

The non-orthogonal local coordinate system 730 is formed by three axes (e₁731, e₂ 732, n 733) being defined as follows:

e₁=N₃−N₁

e₂=N₄−N₂

n=H(e₁×e₂)/∥e₁×₂∥

Lateral force vector F_{L} 702 is decomposed in the local coordinate system 730 as follows:

F_{L}=a e₁+b e₂+c n

F_{R}=−F_{L}

where: a, b, c are coefficients of respective axes.
The counterbalance corner nodal force vectors R₁741, R₂ 742, R₃ 743 and R₄ 744 are then calculated as follows:

R₁=−a n

R₂=−b n

R₃=a n

R₄=b n

Similar to FIGS. 7A-7C, FIG. 7D is a diagram for an example triangular element face 771 and lateral force vector F_{L} 752 acted at an associated perimeter nodal point N 765. Triangular element face 771 is defined by three corner nodes N₁761, N₂ 762, and N₃ 763. Vertical distance is between the perimeter nodal point N 765 and its normal projection point O 773 on the element face 771 is denoted as H 772. A non-orthogonal local coordinate system 780 (e₁781, e₂ 782, n 783) for calculating the set of counterbalance corner nodal forces is shown in FIG. 7E. The first axis e₁781 is a vector defined by N₁761 and N₂ 762, while the second axis e₂782 is a vector defined by N₁761 and N₃ 763. The third axis n 783 is a vector perpendicular to a plane defined by the first and second axes 781-782 with the origin at the normal projection point O 773.

FIG. 7F shows two diagrams illustrating calculation sequence of the set of counterbalance corner nodal force vectors R₁791, R₂ 792 and R₃ 793 at respective corner nodes 761-763. First, a counterbalance force vector F_{R} 753 (i.e., a force equal to F_{L} 752 in opposite direction) is applied at the perimeter node N 765 as shown in the upper diagram. Then, the counterbalance force vector F_{R} 753 is laterally moved to the normal projection point O 773. And angular moment caused by the lateral force vector L_{L} 752 is canceled out by the set of counterbalance corner nodal force vectors 791-793.

The non-orthogonal local coordinate system 780 is formed by three axes (e₁781, e₂ 782, n 783) being defined as follows:

e₁=N₃−N₁

e₂=N₃−N₂

n=H(e₁×e₂)/∥e₁×e₂∥

Lateral force vector F_{L} 752 is decomposed in the local coordinate system 780 as follows:

F_{L}=a e₁+e₂+c n

F_{R}=−F_{L}

where: a, b, c are coefficients of respective axes.
The counterbalance corner nodal force vectors R₁791, R₂ 792 and R₃ 793 are then calculated as follows:

R₁=−a n

R₂=−b n

R₃=a n+b n

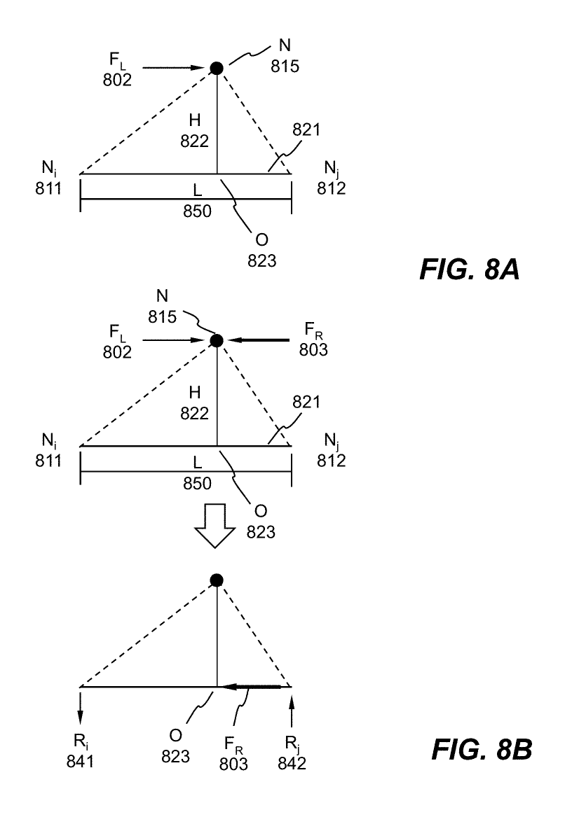

FIGS. 8A is a two-dimensional schematic diagram showing an example relationship between lateral force F_{L} 802 at perimeter nodal point N 815 and two nodes Nᵢ 811 and Nⱼ 812 on the corresponding element face 821. Horizontal distance between the two nodes is L 850. Vertical distance between the perimeter nodal point N 815 and its normal projection point O 823 is denoted as N 822. FIG. 8B shows two diagrams illustrating calculation sequence of a corresponding set of counterbalance corner nodal forces Rᵢ 841 and Rⱼ 842. First, as shown in the upper diagram, a counterbalance force F_{R} 803 (i.e., a force equal to F_{L} 802 in opposite direction) is applied at the perimeter node N 815. Then the counterbalance force F_{R} 803 is laterally moved to the normal projection point O 823. And angular moment caused by the lateral force F_{L} 802 is canceled out by the set of counterbalance corner nodal forces 841-842.

Angular moment is equal to F_{L}×H, which is canceled out by the corresponding set of counterbalance corner nodal forces Rᵢ 841 and Rⱼ 842. Rᵢ 841 and Rⱼ 842 are in opposite direction and equal in magnitude R. Therefore, the corresponding set of counterbalance corner nodal forces does not create any net force in the finite element containing the associated element face.

Due to the lateral distance L 850 between the counterbalance corner nodal forces Rᵢ 841 and 842, an angular moment is created with a magnitude equaling to R×L. Magnitude R is calculated as follows: R=(F_{L}×H)/L.

Those having ordinary skill in the art would know that the magnitude of each set of counterbalance corner nodal forces can be calculated for each pair of associated perimeter nodal point and element face.

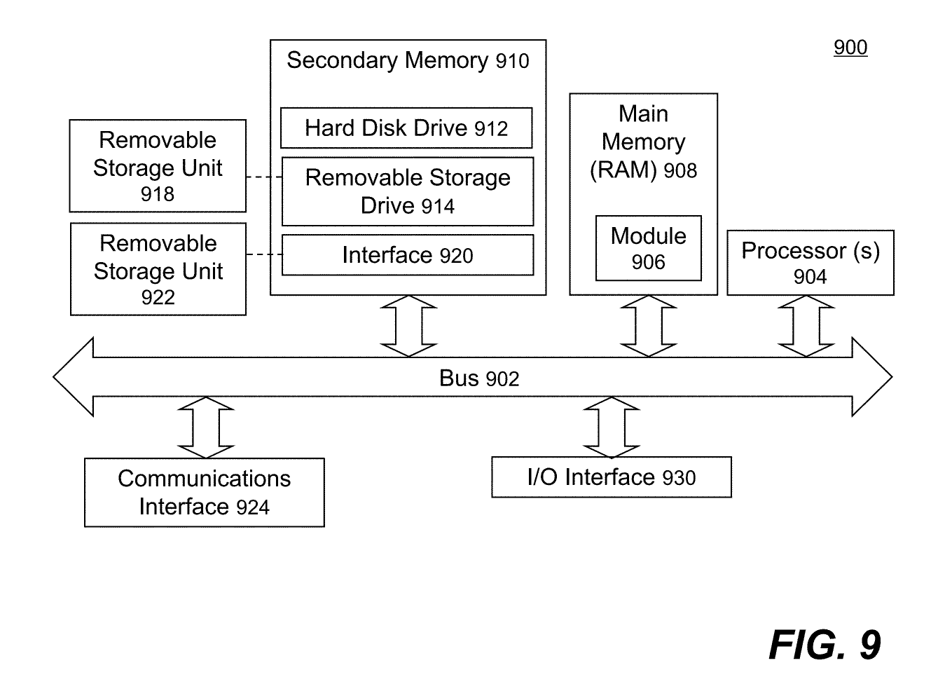

According to one aspect, the invention is directed towards one or more special-purpose programmed computer systems capable of carrying out the functionality described herein. An example of a computer system 900 is shown in FIG. 9. The computer system 900 includes one or more processors, such as processor 904. The processor 904 is connected to a computer system internal communication bus 902. Various software embodiments are described in terms of this exemplary computer system. After reading this description, it will become apparent to a person skilled in the relevant art(s) how to implement the invention using other computer systems and/or computer architectures.

Computer system 900 also includes a main memory 908, preferably random access memory (RAM), and may also include a secondary memory 910. The secondary memory 910 may include, for example, one or more hard disk drives 912 and/or one or more removable storage drives 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc. which is read by and written to by removable storage drive 914. As will be appreciated, the removable storage unit 918 includes a computer readable storage medium having stored therein computer software and/or data.

In alternative embodiments, secondary memory 910 may include other similar means for allowing computer programs or other instructions to be loaded into computer system 900. Such means may include, for example, a removable storage unit 922 and an interface 920. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 922 and interfaces 920 which allow software and data to be transferred from the removable storage unit 922 to computer system 900. In general, Computer system 900 is controlled and coordinated by operating system (OS) software, which performs tasks such as process scheduling, memory management, networking and I/O services.

There may also be a communications interface 924 connecting to the bus 902. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924. The computer 900 communicates with other computing devices over a data network based on a special set of rules (i.e., a protocol). One of the common protocols is TCP/IP (Transmission Control Protocol/Internet Protocol) commonly used in the Internet. In general, the communication interface 924 manages the assembling of a data file into smaller packets that are transmitted over the data network or reassembles received packets into the original data file. In addition, the communication interface 924 handles the address part of each packet so that it gets to the right destination or intercepts packets destined for the computer 900.In this document, the terms “computer program medium”, “computer readable medium”, “computer recordable medium” and “computer usable medium” are used to generally refer to media such as removable storage drive 914 (e.g., flash storage drive), and/or a hard disk installed in hard disk drive 912. These computer program products are means for providing software to computer system 900. The invention is directed to such computer program products.

The computer system 900 may also include an input/output (I/O) interface 930, which provides the computer system 900 to access monitor, keyboard, mouse, printer, scanner, plotter, and the likes.

Computer programs (also called computer control logic) are stored as application modules 906 in main memory 908 and/or secondary memory 910. Computer programs may also be received via communications interface 924. Such computer programs, when executed, enable the computer system 900 to perform the features of the invention as discussed herein. In particular, the computer programs, when executed, enable the processor 904 to perform features of the invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 924. The application module 906, when executed by the processor 904, causes the processor 904 to perform the functions of the invention as described herein.

The main memory 908 may be loaded with one or more application modules 906 that can be executed by one or more processors 904 with or without a user input through the I/O interface 930 to achieve desired tasks. In operation, when at least one processor 904 executes one of the application modules 906, the results are computed and stored in the secondary memory 910 (i.e., hard disk drive 912). Results of the analysis (e.g., computed element forces and of the product/part) are reported to the user via the I/O interface 930 either in a text or in a graphical representation upon user's instructions.

Although the invention has been described with reference to specific embodiments thereof, these embodiments are merely illustrative, and not restrictive of, the invention. Various modifications or changes to the specifically disclosed exemplary embodiments will be suggested to persons skilled in the art. Whereas only relatively small number of perimeter nodal points and element faces in a friction/tied-interface have been shown and described, the invention does not set any limit as to number of perimeter nodal points and element faces, for example, more than one thousand perimeter nodal points and more than one thousand element faces. Furthermore, whereas friction/tied-interface has been shown and described, the invention may be used for treating other substantially similar features such as frictional force in a contact between two portions. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of calculating friction/tied-interface effects in a time-marching simulation for improvement of a product or part comprising:
receiving, in a computer system having finite element analysis (FEA) based application module capable of processing friction/tied-interface installed thereon, a FEA model representing a product or part, the FEA model containing first and second sub-models connected with each other via a friction/tied-interface, the friction/tied-interface connecting at least one perimeter nodal point in the first sub-model to at least one element face in the second sub-model;
associating, with the FEA based application module, each perimeter nodal point in the first sub-model with a particular one of the at least one element face in the second sub-model based on a set of friction/tied-interface criteria; and
obtaining, with the FEA based application module, numerically-calculated structural behaviors of the product or part under a design condition by conducting a time-marching simulation using the FEA model in a number of solution cycles, the numerically-calculated structural behaviors at each solution cycle including effects from respective sets of counterbalance corner nodal forces applied on the at least one element face, each set of counterbalance corner nodal forces being configured for cancelling out an angular moment caused by a lateral force acted at said each perimeter nodal point, and the lateral force being parallel to said associated particular one of the at least one element face;
whereby the numerically-calculated structural behaviors are used for assisting engineers/scientists to make decisions in improvement of the product or part.

2. The method of claim 1, wherein a first of the at least one perimeter nodal point and a second of the at least one perimeter nodal point are associated with different one of the at least one element face.

3. The method of claim 1, wherein a first of the at least one perimeter nodal point and a second of the at least one perimeter nodal point are associated with same one of the at least one element face.

4. The method of claim 1, wherein the set of friction/tied-interface criteria includes:
determining a normal projection point of said each perimeter nodal point to all of the at least one element face; and
selecting the particular one of the at least one element face when the normal projection point is located within the particular one of the at least one element face.

5. The method of claim 1, wherein said each perimeter nodal point is associated with the particular one of the at least one element face in a fixed relative orientation throughout the time-marching simulation.

6. The method of claim 1, wherein said each set of counterbalance corner nodal forces comprises zero net normal force in the particular one of the at least one element face.

7. The method of claim 1, wherein the particular one of the at least one element face comprises a quadrilateral shape.

8. The method of claim 1, wherein the particular one of the at least one element face comprises a triangular shape.

9. A system for calculating friction/tied-interface effects in a time-marching simulation for improvement of a product or part comprising:
an input/output (I/O) interface;
a memory for storing computer readable code for a finite element analysis (FEA) based application module capable of processing friction/tied-interface;
at least one processor coupled to the memory, said at least one processor executing the computer readable code in the memory to cause the FEA based application module to perform operations of:
receiving a FEA model representing a product or part, the FEA model containing first and second sub-models connected with each other via a friction/tied-interface, the friction/tied-interface connecting at least one perimeter nodal point in the first sub-model to at least one element face in the second sub-model;
associating each perimeter nodal point in the first sub-model with a particular one of the at least one element face in the second sub-model based on a set of friction/tied-interface criteria; and
obtaining numerically-calculated structural behaviors of the product or part under a design condition by conducting a time-marching simulation using the FEA model in a number of solution cycles, the numerically-calculated structural behaviors at each solution cycle including effects from respective sets of counterbalance corner nodal forces applied on the at least one element face, each set of counterbalance corner nodal forces being configured for cancelling out an angular moment caused by a lateral force acted at said each perimeter nodal point, and the lateral force being parallel to said associated particular one of the at least one element face;
whereby the numerically-calculated structural behaviors are used for assisting engineers/scientists to make decisions in improvement of the product or part.

10. The system of claim 9, wherein a first of the at least one perimeter nodal point and a second of the at least one perimeter nodal point are associated with different one of the at least one element face.

11. The system of claim 9, wherein a first of the at least one perimeter nodal point and a second of the at least one perimeter nodal point are associated with same one of the at least one element face.

12. The system of claim 9, wherein the set of friction/tied-interface criteria includes:
determining a normal projection point of said each perimeter nodal point to all of the at least one element face; and
selecting the particular one of the at least one element face when the normal projection point is located within the particular one of the at least one element face.

13. The system of claim 9, wherein said each perimeter nodal point is associated with the particular one of the at least one element face in a fixed relative orientation throughout the time-marching simulation.

14. The system of claim 9, wherein said each perimeter nodal point is associated with the particular one of the at least one element face in a fixed relative orientation throughout the time-marching simulation.

15. The system of claim 9, wherein said each set of counterbalance corner nodal forces comprises zero net normal force in the particular one of the at least one element face.

16. A non-transitory computer readable medium containing instructions for calculating friction/tied-interface effects in a time-marching simulation for improvement of a product or part by a method comprises:
receiving, in a computer system having finite element analysis (FEA) based application module capable of processing friction/tied-interface installed thereon, a FEA model representing a product or part, the FEA model containing first and second sub-models connected with each other via a friction/tied-interface, the friction/tied-interface connecting at least one perimeter nodal point in the first sub-model to at least one element face in the second sub-model;
associating, with the FEA based application module, each perimeter nodal point in the first sub-model with a particular one of the at least one element face in the second sub-model based on a set of friction/tied-interface criteria; and
obtaining, with the FEA based application module, numerically-calculated structural behaviors of the product or part under a design condition by conducting a time-marching simulation using the FEA model in a number of solution cycles, the numerically-calculated structural behaviors at each solution cycle including effects from respective sets of counterbalance corner nodal forces applied on the at least one element face, each set of counterbalance corner nodal forces being configured for cancelling out an angular moment caused by a lateral force acted at said each perimeter nodal point, and the lateral force being parallel to said associated particular one of the at least one element face;
whereby the numerically-calculated structural behaviors are used for assisting engineers/scientists to make decisions in improvement of the product or part.

17. The non-transitory computer readable medium of claim 16, wherein the set of friction/tied-interface criteria includes:
determining a normal projection point of said each perimeter nodal point to all of the at least one element face; and
selecting the particular one of the at least one element face when the normal projection point is located within the particular one of the at least one element face.

18. The non-transitory computer readable medium of claim 16, wherein said each perimeter nodal point is associated with the particular one of the at least one element face in a fixed relative orientation throughout the time-marching simulation.

19. The non-transitory computer readable medium of claim 16, wherein said each perimeter nodal point is associated with the particular one of the at least one element face in a fixed relative orientation throughout the time-marching simulation.

20. The non-transitory computer readable medium of claim 16, wherein said each set of counterbalance corner nodal forces comprises zero net normal force in the particular one of the at least one element face.
